(19) United States
(12) Patent Application Publication
(10) Pub. No.: US 2010/0241576 A1
(43) Pub. Date: Sep. 23, 2010

(54) SYSTEM, METHOD AND COMPUTER PROGRAM PRODUCT FOR SOCIAL NETWORK BASED TRANSACTIONS

(75) Inventor: Zohar Beeri, Cresskill, NJ (US)

Correspondence Address: RECHES PATENTS, 211 North Union St., Suite 100, Alexandria, VA, 22314, US

(73) Assignee: Zohar Beeri, Cresskill, NJ (US)

(21) Appl. No.: 12/729,434

(22) Filed: Mar. 23, 2010

Related U.S. Application Data
(60) Provisional application No. 61/210,785, filed on Mar. 23, 2009.

(51) Int. Cl. G06Q 30/00; G06F 15/173; G06Q 99/00; G06Q 10/00; G06Q 20/00

(52) U.S. Cl. 705/80; 709/224; 709/226; 705/14.16

(57) ABSTRACT

A system, method and computer program product that comprises a non transient computer readable medium that stores instructions for: monitoring an offer to enter a transaction, wherein the offer is being distributed over a social networking community by a referring entity; wherein members of the social networking community interact through a network; detecting a completion of the transaction; and compensating the referring entity, wherein the referring entity differs from an initiator of the offer.

### RELATED APPLICATIONS

This application claims the benefit of U.S. provisional patent Ser. No. 61/210,785 filing date Mar. 23, 2009 which is incorporated herein in its entirety.

### FIELD OF THE INVENTION

The invention relates to methods, systems and computer readable mediums that utilize social networks.

### BACKGROUND OF THE INVENTION

Almost every internet user was exposed in recent years to social networks. They start to shape up as the next infrastructure to support a more structured web. Organized around a group of registered users they are built on the premise of user participation and user interaction (otherwise known as “User Engagement”).

This participation starts with enlisting members in those communities through different viral techniques such as invitations based on user's mail address books, and joint connections and creating together meaningful content. The content is usually centered on the expression of political and personal views, pointing to other meaningful content on the web or any other activity that shares content across the network.

The business world has recently started to use those social networks in multiple ways, first as a way to communicate with potential customers or as a way to engage consumers in promotional activities, again related to customer acquisition and retention. However, there has never been an attempt to engage the corporate world by the communities, as there was a missing technology to allow members of a community to monetize such interaction. Thus, a new technology component is missing, that will bridge that gap and allow communities of professionals or experts or any other organized entity to sell products and services (it will also be referred to commonly as “offering”) as a community to businesses.

### SUMMARY OF THE INVENTION

A computer program product that may include a non transient computer readable medium that may store instructions for monitoring an offer to enter a transaction, wherein the offer is being distributed over a social networking community by a referring entity; wherein members of the social networking community interact through a network; detecting a completion of the transaction; and compensating the referring entity, wherein the referring entity differs from an initiator of the offer.

The computer readable medium may store instructions for monitoring multiple distribution attempts of the offer over multiple communities; and compensating referring entities that initiated distribution attempts that directly contributed to the completion of the transaction.

The computer readable medium may store instructions for monitoring multiple distribution attempts of the offer over multiple communities; and assigning an identifier to each distribution attempt; wherein an identifier of a certain distribution attempt is indicative of a referring entity that initiated the certain distribution attempt and of at least one preceding distribution attempt that triggered the generation of the certain distribution attempt. The referring entity may be a community or a sub-community.

The computer readable medium may store instructions for monitoring a virtual negotiation between the initiator of an offer an a third party, wherein the virtual negotiation is conducted by using an access controlled virtual environment after the third party received the offer via the virtual network.

The computer readable medium may store instructions for printing a receipt indicative of a completion of the transaction.

The computer readable medium may store instructions for monitoring multiple distribution attempts of the offer by tracking after social networking share operations.

The computer readable medium may store instructions for detecting a contribution to the social networking community, wherein the contribution is made by a contributing member of the virtual member; and compensating the contributing entity.

The computer readable medium may store instructions for detecting a contribution that is not directly attributed to the completion of the transaction; and compensating the contributing entity.

A system for virtual commerce may include (i) a monitor for monitoring an offer to enter a transaction, wherein the offer is being distributed over a social networking community by a referring entity; wherein members of the social networking community interact through a network; and for detecting a completion of the transaction; and (ii) a compensation module for compensating the referring entity, wherein the referring entity differs from an initiator of the offer.

The monitor may be configured to monitor multiple distribution attempts of the offer over multiple communities; and wherein the compensation module may be configured to compensate referring entities that initiated distribution attempts that directly contributed to the completion of the transaction.

The monitor may be configured to monitor multiple distribution attempts of the offer over multiple communities and assign an identifier to each distribution attempt; wherein an identifier of a certain distribution attempt is indicative of a referring entity that initiated the certain distribution attempt and of at least one preceding distribution attempt that triggered the generation of the certain distribution attempt.

The monitor may be configured to monitor a virtual negotiation between the initiator of an offer an a third party, wherein the virtual negotiation is conducted by using an access controlled virtual environment after the third party received the offer via the virtual network.

The system may be adapted to instruct a printer to print a document indicative of a completion of the transaction.

The monitor may be configured to monitor multiple distribution attempts of the offer by tracking after social networking share operations.

The monitor may be configured to detect a contribution to the social networking community, wherein the contribution is made by a contributing member of the virtual member; and wherein the compensation module may be configured to compensate the contributing entity.

The monitor may be configured to detect a contribution that is not directly attributed to the completion of the transaction; and wherein the compensation module may be configured to compensate the contributing entity.

A method, that may include: monitoring an offer to enter a transaction, wherein the offer is being distributed over a social networking community by a referring entity; wherein members of the social networking community interact through a network; detecting a completion of the transaction; and compensating the referring entity, wherein the referring entity differs from an initiator of the offer.

A computer program product that includes a non transient computer readable medium that may store instructions for: detecting, by a monitor, a completion of a transaction made between a first group of members of a social networking community and a second group of members of another social networking community; wherein an offer to enter the transaction was generated by the first group of members and was distributed over the social networking communities; wherein the members of the social networking communities interact through at least one network; and allocating, by a compensation module, funds received from the transaction between members of the first group of members based on an agreement between the members of the first group of members, the agreement being accessible to the compensation module.

A method that may include: detecting, by a monitor, a completion of a transaction made between a first group of members of a social networking community and a second group of members of another social networking community; wherein an offer to enter the transaction was generated by the first group of members and was distributed over the social networking communities; wherein the members of the social networking communities interact through at least one network; and allocating, by a compensation module, funds received from the transaction between members of the first group of members based on an agreement between the members of the first group of members, the agreement being accessible to the compensation module.

### BRIEF DESCRIPTION OF THE INVENTION

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

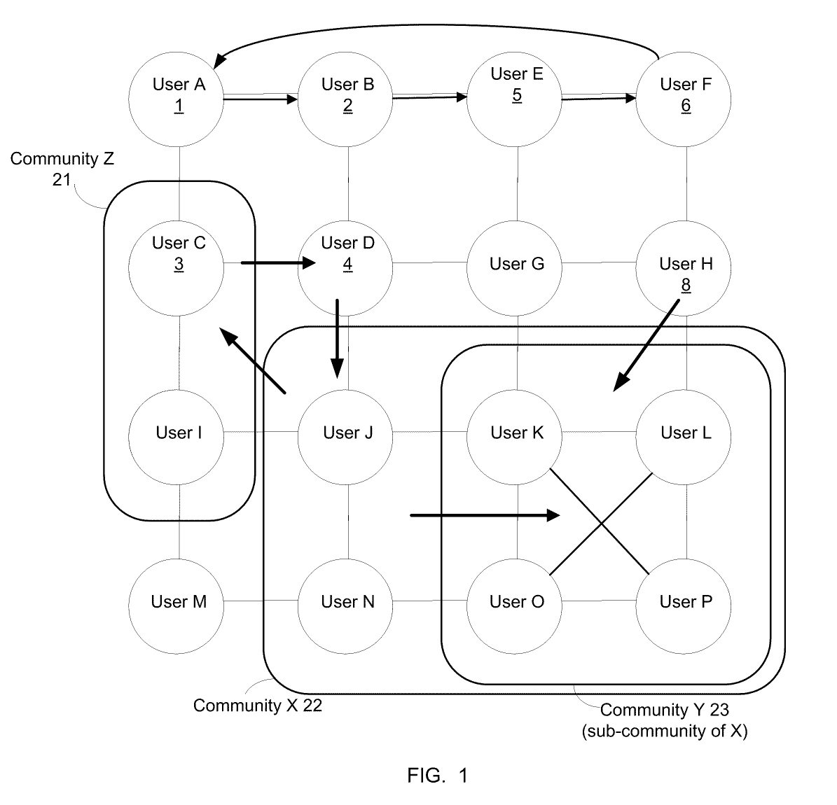

FIG. 1 illustrates relationships between various entities that use social networks to distribute offers to enter a transaction according to an embodiment of the invention;

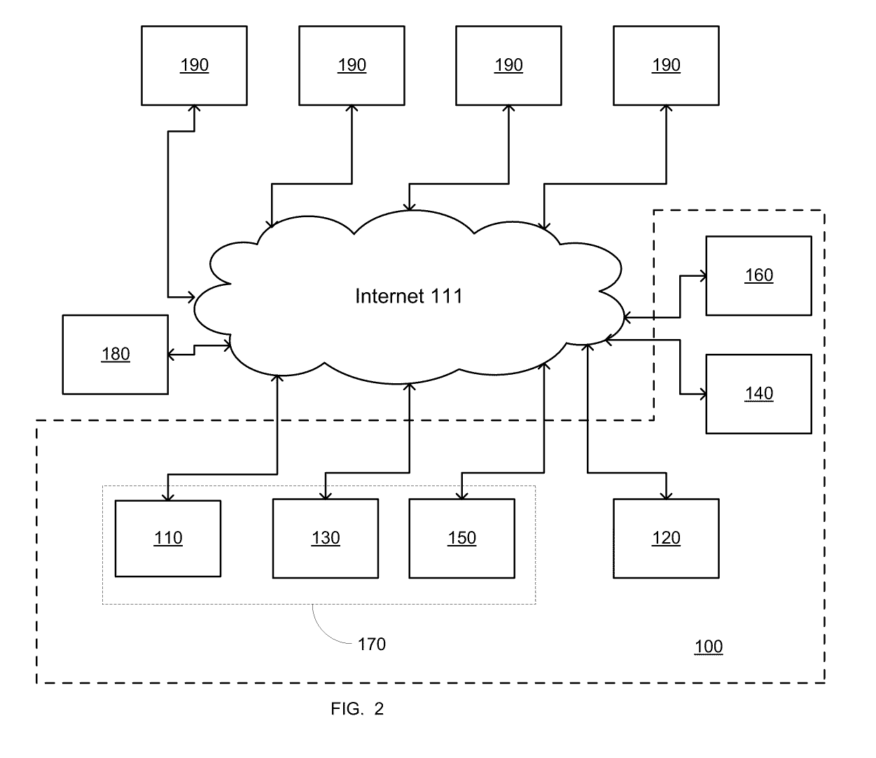

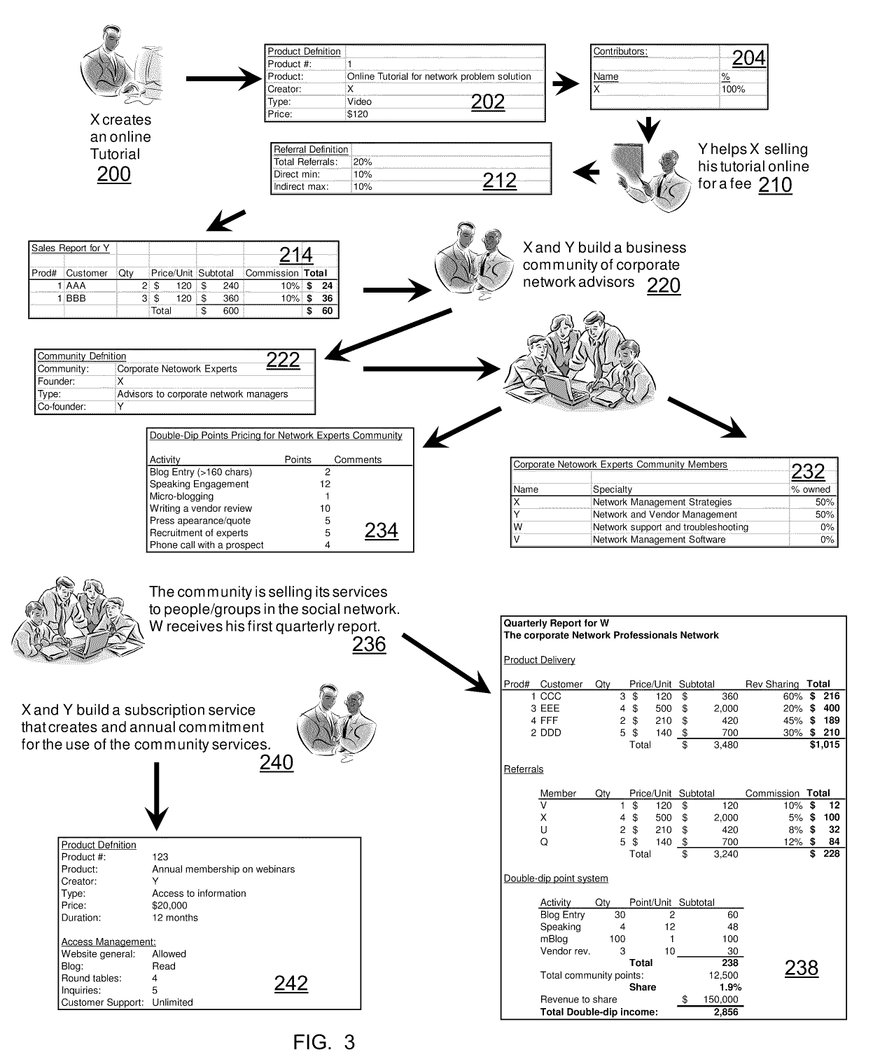

FIG. 2 illustrates a system according to an embodiment of the invention;

FIGS. 3, 4 and 5 illustrate examples usages of the system of FIG. 1 according to an embodiment of the invention;

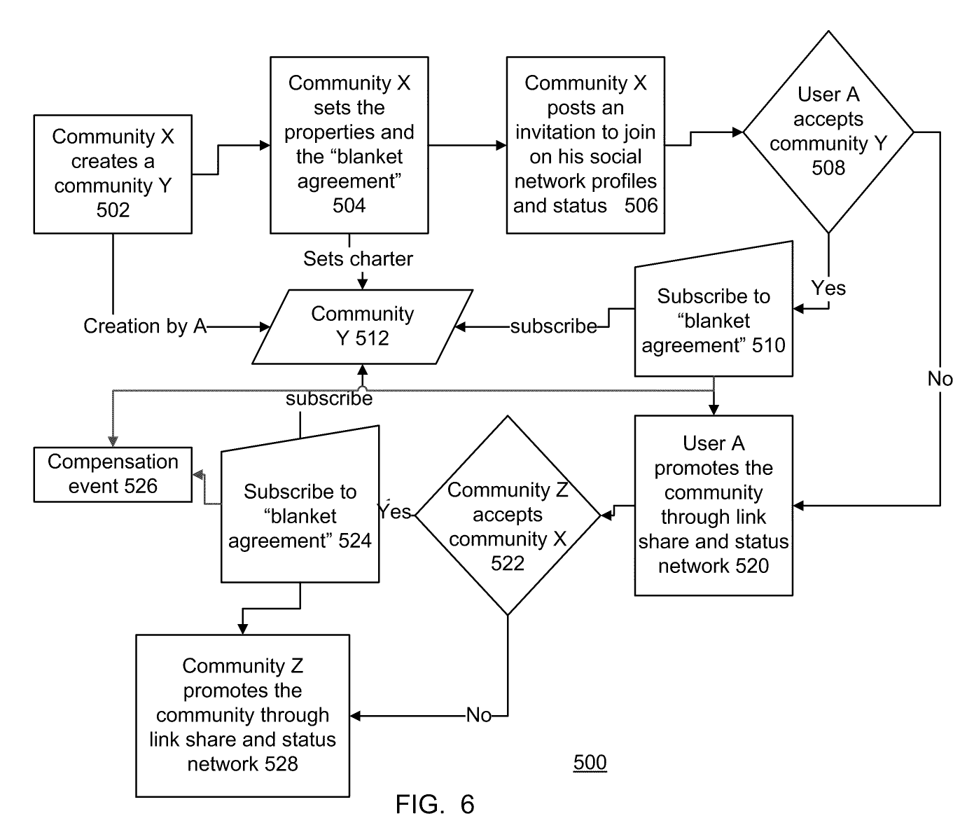

FIG. 6 illustrates a method for creating a virtual sub-community according to an embodiment of the invention;

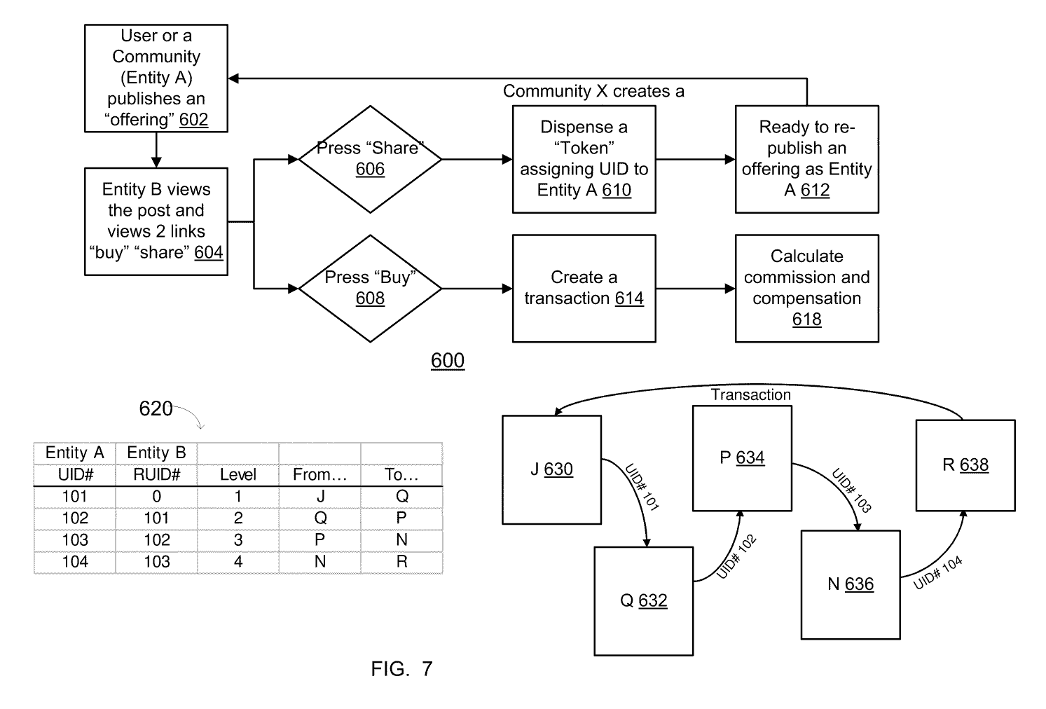

FIG. 7 illustrates a method according to an embodiment of the invention;

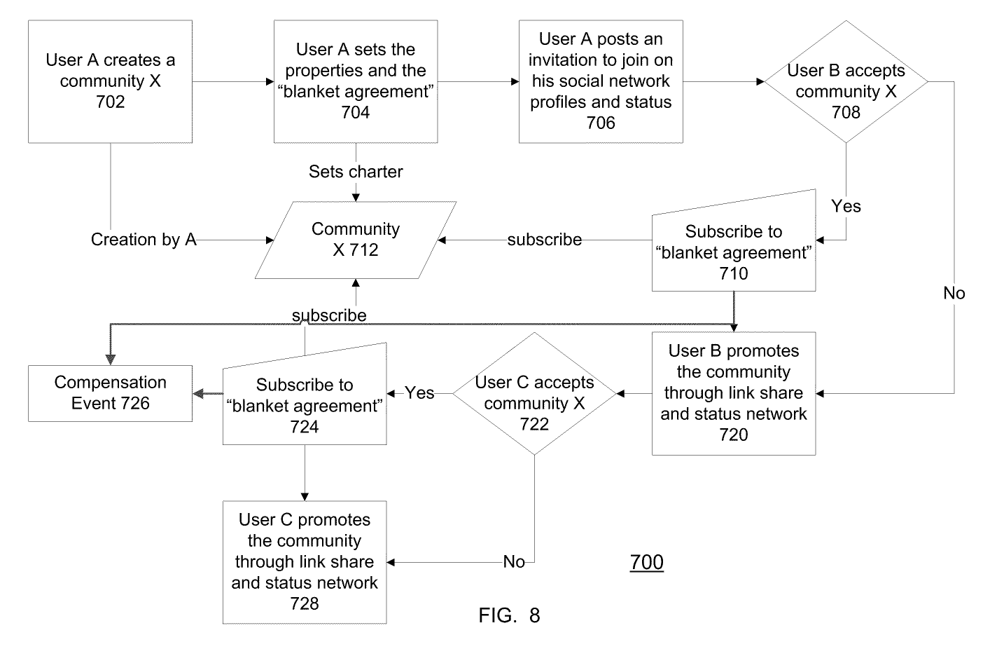

FIG. 8 illustrates a method according to an embodiment of the invention;

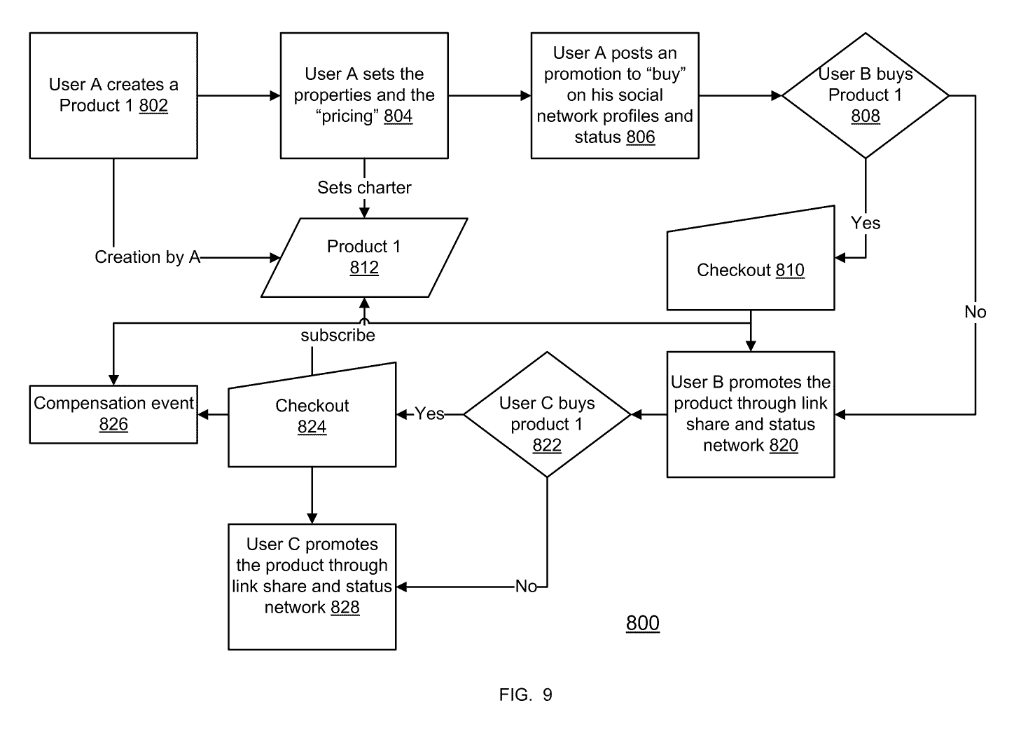

FIG. 9 illustrates a method according to an embodiment of the invention;

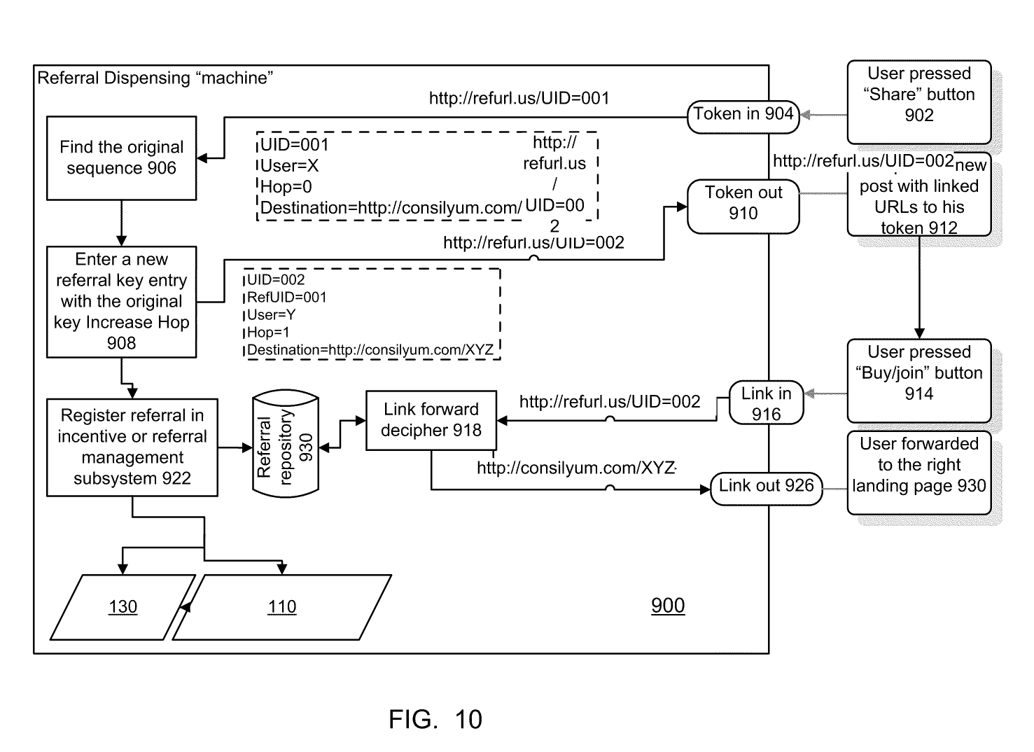

FIG. 10 illustrates a referral dispensing machine, according to an embodiment of the invention;

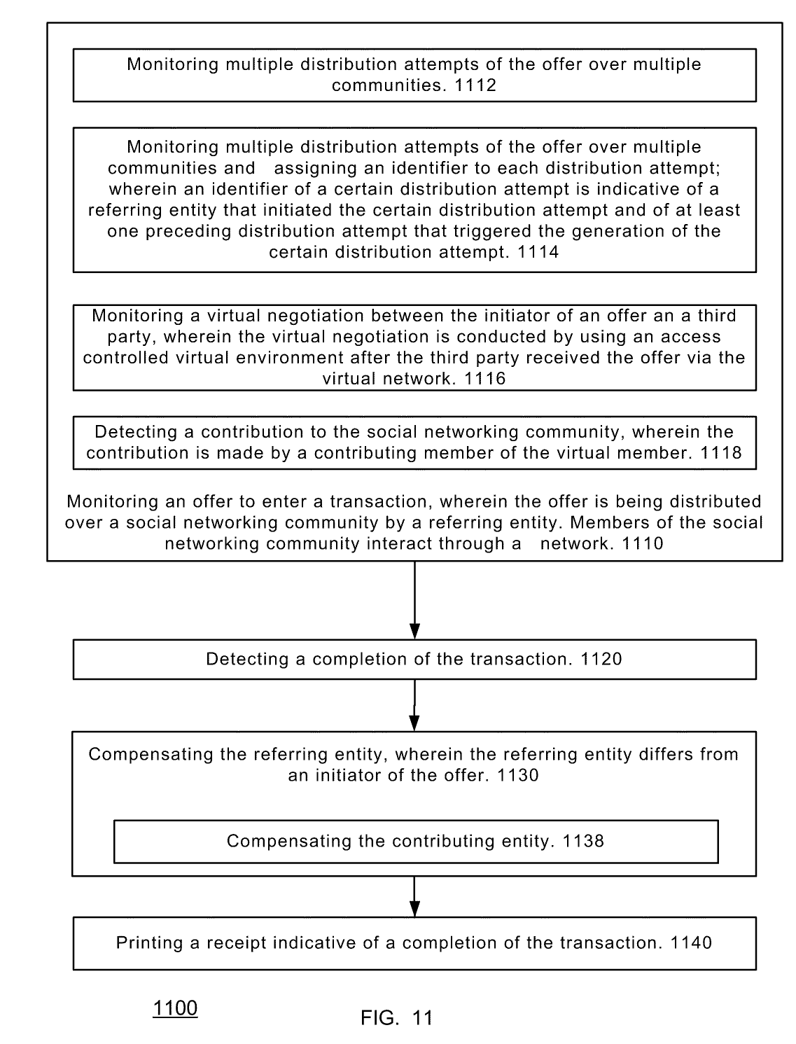

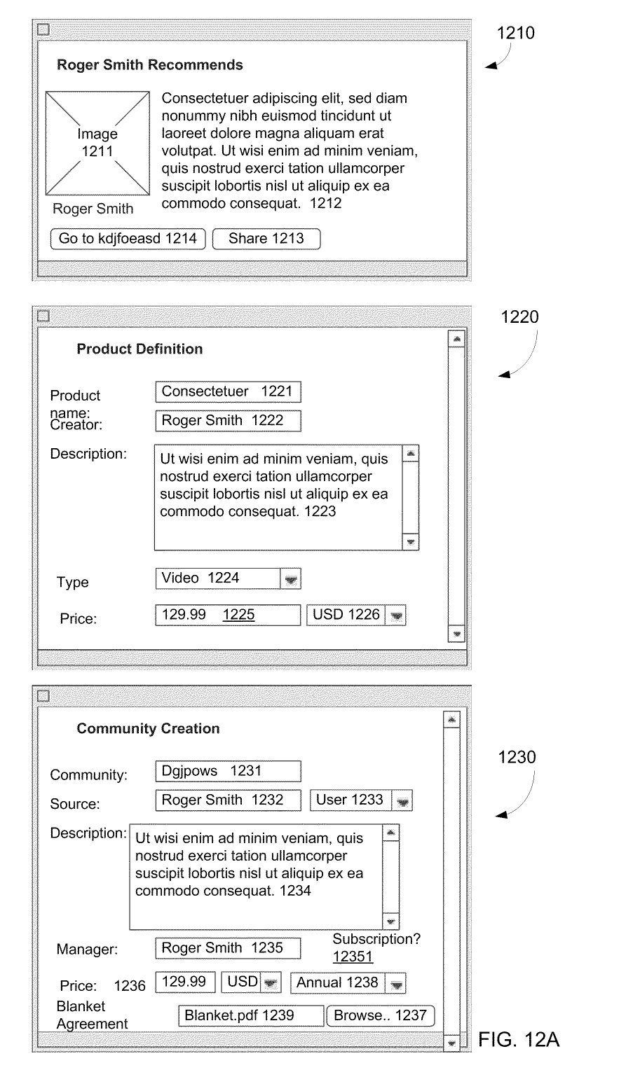

FIG. 11 illustrates method 1100 according to an embodiment of the invention;

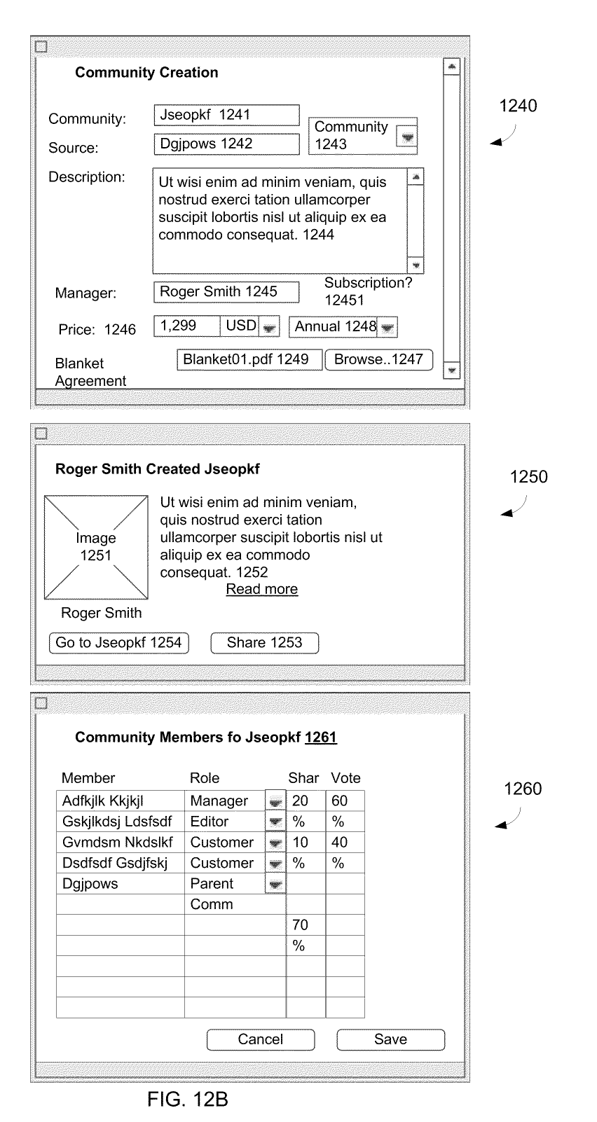

FIGS. 12A and 12B illustrate portions of a webpage that is displayed to users that access a social networking website according to an embodiment of the invention;

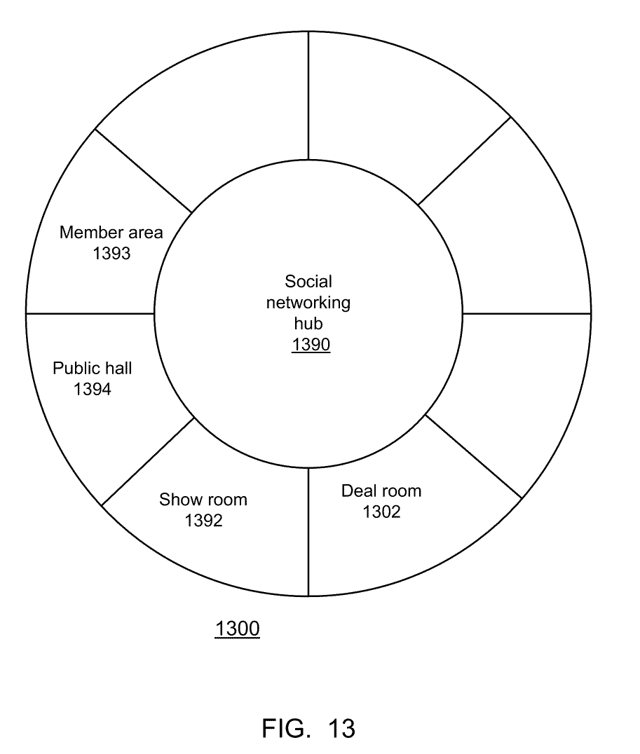

FIG. 13 a virtual environment according to an embodiment of the invention;

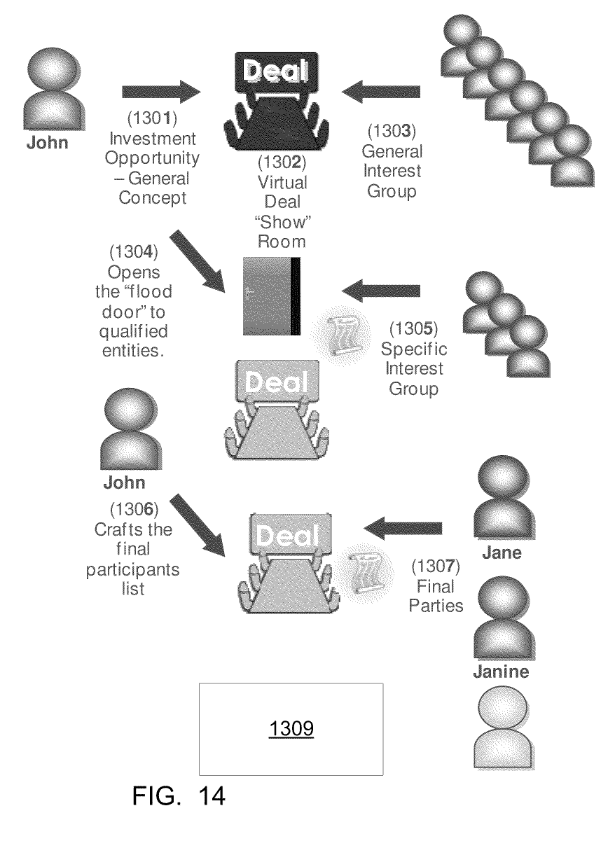

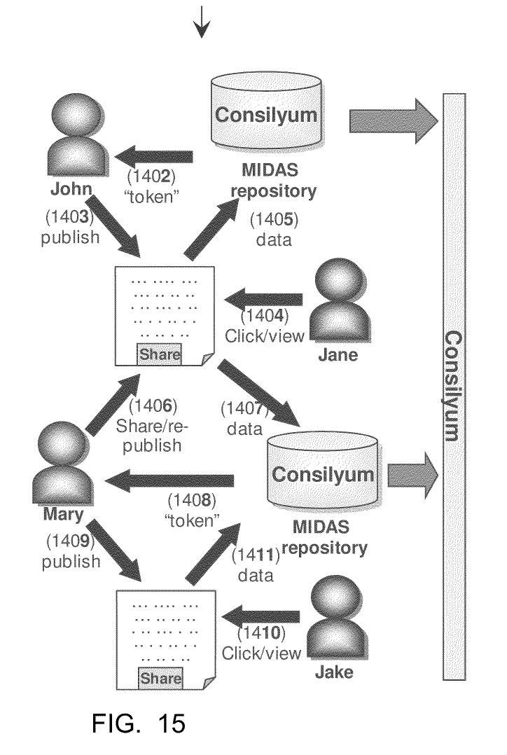

FIGS. 14 and 15 illustrate various transactions according to an embodiment of the invention; and

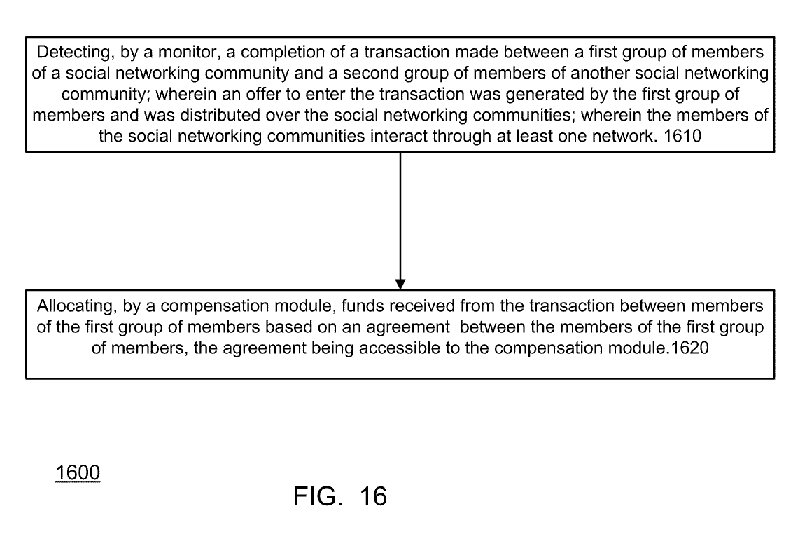

FIG. 16 illustrates a method according to an embodiment of the invention.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A method, a computer program product and a system are provided. They allow members of social networking communities to monetize and reward participants in social networking communities for activities (such as different services, digital rights or any other activity that may seem of value to the seller and buyer) generated by and for individual members, groups and communities in such social networks.

The term “social network” means any online social networking community (also referred to as “community”) formed through an initial set of founders who invite members to join their site. The term “social network” also means the technology (such as social networking websites) that allows persons to form social networking communities. Example of tools that facilitate social networking communities include MySpace, Friendster, Facebook, LinkedIn, Orkut, Xing, Geni, Plaxo or the like. Internet social networks may be also sites that register clients and allow for simple user registration and subscription services for broadcasting messages or content such as Twitter, YouTube, MetaCafe and any similar services including RSS-enabled blog sites.

The system, method and computer program product may (i) allow individual or groups of members of social network to sell diverse products and services to other members of the social network or to external entities; (ii) allow a group or community of members (“community”) to create a compensation mechanism related to selling of products or services as a group, sub-group or individuals in that community; (iii) provide a tool for the community to reward individuals or sub-groups within a community that promote, advertise, resell or otherwise assist in the actual selling of a product or service, and reward him/them for this referral; (iv) provide a tool for the community to reward individuals or sub-groups within a community that support activities in the group, that promote mutual revenue creation through an internal compensation engine.

At least some of the mentioned above targets can be obtained by using a system, method and computer program product that may allow “spontaneous” yet controlled organizations, with robust and inherent (yet flexible) mechanism to allow users to connect together to supply a joint offering, allows different entities to help each other sell goods and services, and otherwise promote any such organization, including incentivizing non-monetary results, and may serve as an infrastructure to support the deal, including monetary and offerings flow across the network

According to various embodiments of the invention a completion of a transaction can include a payment to the offering (service or product) provider (offer initiator) for providing the service or product. The provider could be an individual or a group. The completion of the transaction may be followed by at least one of the following: (i) payment to a referring entity (individual or group) that referred the parties involved in the transaction. The payment to a group could be to a viral stream of individuals or groups, according to pre-defined policies; (ii) allocation of money to a fund (or any other buffer or other mechanism that may delay the payment to a later point of time) that manages the compensation for services rendered to support the sale, but cannot be directly associated with a specific sale, or as otherwise known as the “double dip” incentives system. Those provisioned funds may be provided later (at known time intervals—monthly, quarterly, annually) allocated according to a point system that will be managed by group or individuals, and presented on a timely basis as a proportional element; (iii) Distribution of money to owners of the offering, either individuals or groups, organized together as owners of the product.

The mentioned above “double-dip” incentive may include calculating incentive points and then allowing an individual or a group to reward others on the merit of providing service that not necessarily resulted in revenue, a creation of content such as writing a blog entry, . . . , such as community management/moderation activities, crafting a marketing document or any similar service.

Every income from selling a product (or supplying a service) will carry a provisional amount that will be added to a separate incentive fund which belongs to a social networking community. This fund may be distributed every period (quarter, month, year etc.) according to the people that made those contributions, as a proportion of all other contributions. A point-based system will be tallied and funds will be distributed on a proportional basis. For instance a group may decide to allocate 12% of all it's revenues to the incentive system. If an individual or group collects 100 of 1,000 points collected by the group that their part of, they will get 10% of the incentive fund.

Referrals may be one of the most powerful tools in viral marketing. They allow for people to be compensated for providing a service that will result in a selling of an offering. Unlike a point incentive (double-dip) activity, which can also not be associated with a dollar of revenue, referrals are associated and debited against an amount of revenue. However referrals could work on a viral mode allowing people to “post” their available referrals, on their profiles for people to “grab” and “post” on their site. This will allow applications far beyond the simple one, mentioned in the examples, but also for instance viral ad campaign. Where the network will be rewarded on “click to conversion” revenue, where a user can post an ad, one of his pals will post it too (referred from the first one), and his friend too (referred from the second one), and so on, until a network will be able to post ads and get rewarded as a network.

A system may be provided that supports “Double Dip” incentives (also referred to as indirect incentives), referral incentive and manage access to offers for a transaction, and may manage the provisioning of products and services (provided by the access subsystem), while able to mitigate risks of abuse and misuse of the system and give an alert to groups or individuals, that run those communities or provide services when there's a problem and manage access th the system.

FIG. 1 illustrates relationships between various entities that use social networks to distribute offers to enter a transaction according to an embodiment of the invention.

A community can create one or more sub-communities. Each sub community has a single parent community. A sub-community may “inherit” the features of its parent community and can add to it. The sub-community may inherit key features, most notably candidate members and contextual and mission statement. A community in this way can also inherit ownership and can become an owner itself of the sub-community. A sub-community created from an existing community, may inherit some of the features, such as a “deal” framework, or other features. An example; a community of cardiologists, may create a sub-community of non-invasive cardiologists. The members of the sub-community may inherit the right to access the information in the parent community and are selected from the members of the parent community, and so forth. A sub-community may be formed in order to further differentiate between members of a community or to allow some members of the community to engage in specific (more enhanced) activity such as signing a contract. For instance, the need to sign an NDA to view private documents or to enter the sub-community may require subscription fees, or other qualifications. A transaction may be offered to the entire community but just those interested in the transaction may enter a sub-community that is targeted in completing the transaction. This sub-community may also be split to members that are willing to pay fees, sign a non-disclosure agreement and negotiate the terms of the transaction. Each of these prerequisites may form a smaller sub-community.

A user can be an owner of one or more communities and, additionally or alternatively, may be subscribed to one or more other communities.

A community can be regarded as an asset that is a subject matter of a transaction—for example by charging “membership” fees or subscription that may be defined per period, per a certain amount of actions and the like.

A user can own products or offerings that are time associated or items, such as content. Time associated products or offering may be charged per time unit (subscription, consulting fees . . . ).

Transactions can be made and offers to enter a transactions can be generated and distributed by communities, sub-communities or individual users.

A transaction starts by an initiating entity that generates an offer to enter a transaction. The offer may be distributed by one or more referral entities. A transaction is completed between the initiating entity (the seller) and another entity (the buyer). The terms “seller” and buyer” are used for brevity of explanation as the transaction can include assigning rights that differ from ownerships. For example a transaction may involve leasing an asset, gaining access to an asset, and the like.

Each entity can utilize a social network for distributing an offer from another entity, for initiating an offer and distributing its offer and for completing a transaction. The distribution may be made by using the “share” process provided in social networks.

A completion of the transaction triggers a commission phase (or compensation phase).

Each entity can participate in activities which not necessarily generate revenues, but create value for their community or sub-community or for any other entity in the system, which triggers a compensation in value that translate (or not) to monetary compensation.

Users may promote an offering (any) and distribute it through their social networks, and each of their contact can do it too. An offer to enter a transaction is distributed by using the social networks and its passage through these social networks is registered and monitored.

The offer can be distributed via one or more distribution attempts. Some distribution attempts directly contribute to a completion of a transaction and the users (or communities) that initiates these attempts should be rewarded as apart of a referral based incentive scheme.

FIG. 1 illustrates four offers.

A first offer is generated by user A 1 and propagates (using social networks) via users B 2 and E 5 until reaching user F 6 that accepts the offer and completes the transaction (an arrow from user F to user A is indicative of a completion of the transaction).

A second offer is generated by first community Z 21, propagates (using social networks) via user D 4 until reaching second community X 22 that accepts the offer and completes the transaction (an arrow from community X 22 to community Z 21 is indicative of a completion of the transaction).

A third offer is generated by second community X 22 and propagates (using social networks) to sub-community Y 23 of second community 22.

A fourth offer is generated by user H 8 and propagates to sub-community Y 23.

FIG. 2 illustrates system 100 and its environment according to an embodiment of the invention.

FIG. 2 provides a high-level outline of the components of system 100. It is noted that the components described are listed for abstraction purposes to demonstrate functionality, while the actual system may include more components or less, nevertheless supporting the critical functionality described above and additional elements of that functionality required to perform the task outlined in the objectives and uses of the monetization system.

System 100 includes billing subsystem 110, access management subsystem 120, referral subsystem 130, support subsystem 140, double dip subsystem 150 and monitor 160.

Billing subsystem 110, referral subsystem 130 and double dip subsystem 150 or at least portions of these subsystems form compensation module 170.

System 100 may include one or more servers or computational resources that may for a part of the Internet or be capable of exchanging information with the Internet infrastructure. FIG. 2 illustrates these subsystems as being connected to an Internet cloud 111.

FIG. 2 also illustrates social networking web servers 180 that maintain a social networking web site (not shown).

Multiple users 190 are connected to Internet cloud 111 and may access system 100 and social networking web servers 180.

Billing subsystem 110 may be configured to charge a users (including a business or businesses) for offerings rendered by an individual, group of individual members or an entire community, based on a pre-defined definition either offering (deliverables), time (subscription), owner (seller) or access to content type, or combination of any of the above.

Access management subsystem 120 may be configured to allow a gated access to resources intended either to customers or to providers of services of the entire system according to pre-defined parameters. This subsystem may be regarded as a provisioning subsystem. It may selectively allow user sto enter communities or sub-communities according to predefined prerequisites.

Referral subsystem 130 may allow individuals, group of individual members or an entire community to be compensated for generating revenue from a business provided to any other individual, group of individual members or an entire community, otherwise could be defined as referral fees. Unlike current practices, the system makes sure that referral are being provided based on actual business outcome, not just for “selling” a contact, and maintains integrity for a period of time, allowing to define referral fees in the context of time too. Referral subsystem 130 can store referral agreements that determine how referral funds should be allocated.

Support subsystem 140 may manage service provisioning between members of the social networking community related to the generation of specific and concrete deliverables, such as assistance or support for the delivery of services to any individual, group of individual members or an entire social networking community.

Double-dip subsystem 150 may manage a compensation mechanism for non-revenue baring activities created by an individual or a group of individual members for the support of activities related to the promotion, “back-office” operations and creation of value (content, construct, services etc.). This point incentive subsystem's objective is to bridge the gap between revenue generating activities and activities that create value for the social networking community but could not be categorically identified with a creation of concrete revenue. To further understand and differentiate this system from the referral subsystem, it could be described as a compensation system for activities that could not be directly associated with a delivery of a specific offering but defined as a result from the activity of a group of individuals and products organized around a community. Double dip subsystem (also referred to indirect subsystem) 150 can store double dip agreements that determine how double dip funds should be allocated.

According to an embodiment of the invention monitor 160 is for monitoring an offer to enter a transaction. The offer is being distributed over a social networking community by a referring entity. Members of the social networking community interact through a network such as the Internet. Monitor 160 may also detect a completion of the transaction.

The detection of the completion of the transaction can be implemented in various manners. It may be based on a networked service, on reports made by members, on the billing subsystem 110, and the like. For example, in the investment community for instance, it is contemplated that any commercial bank signed will have to report back completed transactions to the system.

Compensation module 170 is for compensating the referring entity, wherein the referring entity differs from an initiator of the offer.

Monitor 160 may monitor multiple distribution attempts of the offer over multiple communities and compensation module 170 may compensate referring entities that initiated distribution attempts that directly contributed to the completion of the transaction.

Monitor 160 may monitor multiple distribution attempts of the offer over multiple communities and assign an identifier to each distribution attempt; wherein an identifier of a certain distribution attempt is indicative of a referring entity that initiated the certain distribution attempt and of at least one preceding distribution attempt that triggered the generation of the certain distribution attempt.

Monitor 160 may monitor a virtual negotiation between the initiator of an offer an a third party, wherein the virtual negotiation is conducted by using an access controlled virtual environment after the third party received the offer via the virtual network. FIGS. 14 and 15 illustrate such a scenario.

System 100 may print a document indicative of a completion of the transaction, of a transfer of funds, of a completion of the transaction, and the like. Additionally or alternatively, system 100 may instruct a printer of a user to print the receipt.

Monitor 160 may monitor multiple distribution attempts of the offer by tracking after social networking share operations.

Monitor 160 may detect a contribution to the social networking community, wherein the contribution is made by a contributing member of the virtual member; and wherein the compensation module 170 may be configured to compensate the contributing entity. This contribution may not be directly attributed to the completion of the transaction; and wherein the compensation module may be configured to compensate the contributing entity.

Non limiting examples of the manner in which system 100 operates are provided below. It is noted that other scenarios (including, for example, more complicated scenarios) can be supported by system 100.

### Usage Example 1

FIG. 3 illustrates an example of a usage of system 100 of FIG. 2 according to an embodiment of the invention.

X generates (200) a video asset. The video asset is defined in metadata 202. At this time the only contributor is X—as illustrated by contribution metadata 204.

X is an initiating entity as he generates an offer to enter a transaction relating to the video asset. The video asset describes how to handle a technical problem in a corporate network. X may sell the video asset to his contacts and they would pay him though billing subsystem 110. The video asset would be posted on his profile as a non-free item, and people would approve its purchase from within the online community.

Another social networking community member, Y (a referring entity) wishes to help X by selling this video asset. Y posts the video asset on his own online profile (either within a social networking community, or even as a link from the outside—for example from a token dispensing mechanism) and one of the other members of that social networking community, by pressing that link, accesses the offer to purchase the video asset and purchases it. Referral subsystem 130 and billing subsystem 110 manage a transfer of some funds from X to Y. The distribution of funds between X and Y is described in referral metadata 212. A sale report that illustrates the sales that were contributed to B is illustrated by sales metadata 214.

Assuming that X and Y are members (among others) of an online community of corporate network experts—they may form a sub-community (box 222). In this network each member (like X and Y) uses the online social network to publish those tutorials for people to buy. The members of this corporate network sub-community are listed in box 232. The corporate network members may publish their service by using virtual networks (as indicated in box 236).

X and Y discover that they need to engage the potential buyers by offering them “freebees” in the form of free content. They understand that this activity is of great value to their virtual organization though it produces no immediate or directly associated revenues. They may use the “Double-dip” point incentives subsystem to compensate other people (contributing members) for time and efforts performed in the context of those activities. Thus, they effectively create back-office operations to their network, deciding at each point what activities would be compensated by a point system. They also decide on the percentage from revenues that will be allocated by their community to be paid to the members according to the level of services performed according to the chart. The double dip incentive program related to these corporate members is illustrated by box 234. Box 238 illustrates a detailed billing report that indicates which funds were paid in relation to the video asset, referral fees and double dip fees.

The community that X and Y helped to create is growing; they have many that joined to sell their services through the community and many more customers come to the online store, organized as a community itself to buy the products. X and Y realize that they need to consolidate the two communities and have a single community, where usage base (buyer or seller type) can be defined and they create a system that can control usage levels. Responding to requests from customers, they build an annual service, which provides unlimited access to the content for an annual subscription. They utilize an access management subsystem to manage the controlled access of members and customers (sellers and buyers) to the content using subscription or timed access fees to the community

Box 242 describes metadata that is used to define the newly defined product—the annual membership.

### Usage Example 2

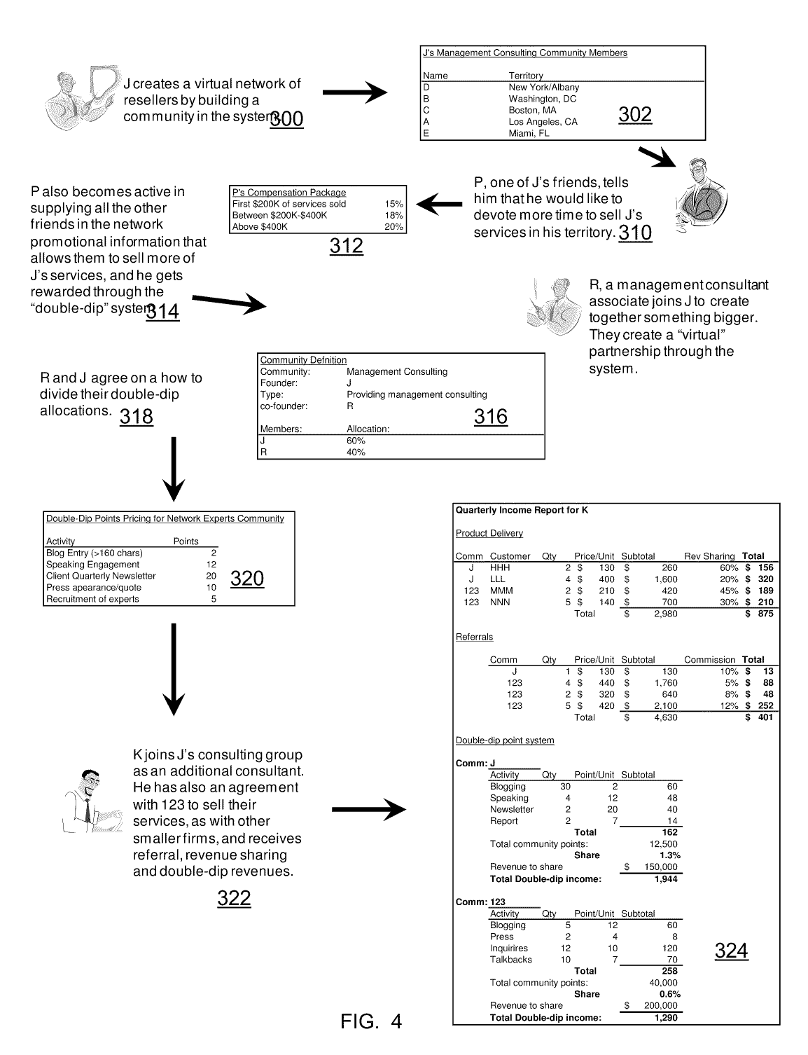

FIG. 4 illustrates an example of another usage of system 100 of FIG. 2 according to an embodiment of the invention.

J (initiating entity) decides to start selling his management consulting services to businesses in his area. He has been utilizing for a while social networks as a tool to keep contact with his former colleagues and potential customers. The community members of the community created by J are listed in box 302. J wants to grow and to reach more people. J realized that just asking friends to connect him with his friends does not bring the required effort to make those meetings happen. He decides to use the Referral subsystem.

J provides (virtually, through a tailored marketing engine) for every friend on his social network a unique link identifier to the sales pages on his site or on his page on the online social network of his choice. This is illustrated by box 300. Now he can associate any unique contact with a specific referral from a friend. His friends are very active and soon he has increased his reach and the sales of his product.

Two months later, his friend from his old employer, P, calls him. P just started a new business and would love to represent J in his territory. This is illustrated by box 310. J may access referral subsystem 130 and creates a new virtual contract with P, based on the contacts P provides. Since P is selling J's services, with a scaled compensation that allows P to sell and get rewards for his efforts. This scaled compensation scheme is illustrated by box 312. J also becomes active in supplying all other friends in the network promotional information that allows them to sell more of J's services and he gets rewarded via the Double Dip system—as illustrated by box 314.

J is doing great and actually decides that, because of the large work load he has, he needs people to share the burden with him. He contacts R, another management consultant J worked for and creates a virtual partnership (box 316 illustrates a social networking community metadata that describes the partnership) with him, to share the revenues (and the associated referral costs) that they share in their business. This is illustrated by box 310.

Now that P sells a service that either J or R can deliver, they have an internal arrangement (box 318) on distribution of proceeds that they both signed on to. J wants to assign R some additional responsibilities, such as creating a client quarterly newsletter, informing customers on the latest additions to the service, as well as news related to the field of management consulting they work for.

Both sign on a virtual agreement generated by the “Double-dip” subsystem that assigns the margin sharing agreement they reached concerning the distribution of a fixed percentage of revenues. The double-dip pricing metadata is illustrated by box 320.

With time J realizes he requires more resources to deliver the consulting projects and he hires more people with similar arrangements as with P, letting them subscribe to the same agreement. One of them K, has a similar arrangement with another social network and he himself is not only delivering J's offerings but also resells 123's (company 123 sells packaged consulting engagements) offering, using the same referral subsystem to determine the financial details, and he is also running his own network selling online tutorials on how to run a social-based business in the twenty first century, using the same subsystems J is using. The cooperation between J and K is illustrated by box 322. An income report that includes referral fees and double-dip fees is denoted 324.

### Usage Example 3

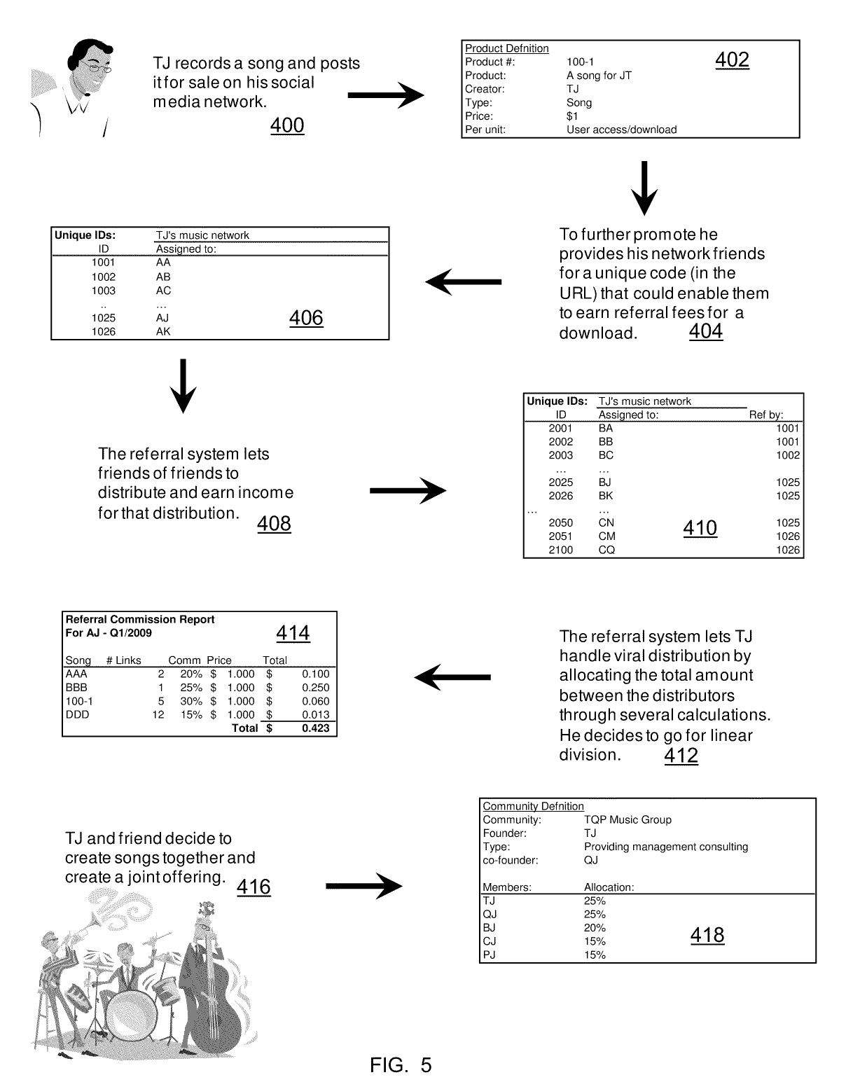

FIG. 5 illustrates a further example of another usage of system 100 of FIG. 2 according to an embodiment of the invention.

TJ just recorded a song (box 400) he's been working on for the last couple of weeks. He decides to use the social network as a distribution channel to sell his song. The song is described by metadata 402. TJ invites his friends (box 404) to join a virtual blanket distribution agreement on the Referral subsystem, assigning each friend a unique URL that identifies paid downloads with the referred friend. The mapping between friends and unique ID is illustrated by box 406.

TJ also lets the Referral subsystem know that he's enabling delegation, allowing his friends to re-distribute to their friends (as illustrated by boxes 408, 410 and 414), links to the song, thus allowing the creation of a viral network that sells his songs. He defines the way referrals will be distributed between his network friends, allowing them to buy, buy and recommend or just recommend the song and earning money through the Referral system. A metadata describing unique identifiers assigned to friends of TJ and second tier friends is illustrated by box 410. A linear referral scheme is illustrated by box 414.

TJ's good friend AJ actually managed to get enough commissions from referrals that he could afford buying TJ's album himself. Seeing AJ's enthusiasm, TJ decides to call up the music networking group that he's been meeting with. Apparently they just organized a virtual network to help sell each other's music by sharing their social networks. While some are on Facebook and some on other platforms they are able to cross-sell and cross-promote each other's music albums and gain from both direct revenues and referrals. Some of them decided to join together in a band (box 416) and actually share the revenues according to an arrangement they created and memorialized using the Billing subsystem. A definition of the newly defined social networking community is illustrated by box 418.

FIG. 6 illustrates method 500 for creating a virtual sub-community according to an embodiment of the invention. Table 1 illustrates the various stages of method 500 and the connections between them.

TABLE 1

| | | Next | Next | |
|---|---|---|---|---|
| | | stage if | stage if | Next |
| stage # | Description | “yes” | “no” | stage |
| 502 | Community X creates community Y | | | 504 |
| 504 | Community X sets the properties | | | 506 |
| | of community Y and determines a | | | |
| | blanket agreement | | | |
| 506 | Community X posts an invitation | | | 508 |
| | to join the community on a | | | |
| | social network profile of | | | |
| | community X and status | | | |
| 508 | User A accepts the invitation | 510 | 520 | |
| | to join community X? | | | |
| 510 | User A subscribes to the | | | 512, |
| | blanket agreement | | | 526 |
| 512 | User A becomes a member of | | | — |
| | community Y | | | |
| 520 | User A promoted community | | | 522 |
| | Y through link share | | | |
| | and status network | | | |
| 522 | Community Z accepts the | 524 | 528 | |
| | invitation to join community Y? | | | |
| 524 | Community Z subscribes to | 526 | 528 | |
| | community Y | | | |
| 526 | Compensation event occurs | | | |
| 528 | Community Z promotes | | | |
| | community Y through link | | | |
| | share and status network | | | |

FIG. 7 illustrates method 600 according to an embodiment of the invention. Table 2 illustrates the various stages of method 600 and the connections between them.

TABLE 2

| | | Next |
|---|---|---|
| stage # | description | stage |
| 602 | Initiating entity A (community or user) publishes | 604 |
| | an offer to enter a transaction. The offer is published | |
| | over virtual networks and is associated with a “buy” | |
| | link and a “share” link | |
| 604 | Another entity (entity B) views the publication and is | 606, |
| | requested to elect between the “buy” link and the | 608 |
| | “share” link | |
| 606 | Entity B elects the “share” link | 610 |
| 608 | Entity B elects the “buy” link | 614 |
| 610 | User B dispenses a “token” assigning a UID | 612 |
| | to entity A | |
| 612 | User A is ready to re-publish the offer - as originally | 602 |
| | posted by entity A. The link to that offer is modified | |
| | to indicate the referral by B | |
| 614 | User B completes the transaction by accepting the offer | 618 |
| | and paying | |
| 618 | Compensation (including possible referral and double | |
| | dip payments) are calculated | |

FIG. 7 also illustrates a sequence of six publication attempts that result in a completed transaction.

J (box 630) is the initiator of the offer to enter a transaction. J publishes the offer to Q (box 632). This distribution attempt is associated with an identifier that identifies J as an initiator of the distribution attempt.

Q publishes the offer to P (box 634). This distribution attempt is associated with an identifier that identifies P as the entity that initiates this second distribution attempt.

P publishes the offer to N (box 636). This distribution attempt is associated with an identifier that identifies N as the entity that initiates this third distribution attempt.

N publishes the offer to R (box 638). This distribution attempt is associated with an identifier that identifies R as the entity that initiates this fourth distribution attempt. R selects to complete the transaction.

Table 610 illustrates the mentioned above identifiers.

FIG. 8 illustrates method 700 according to an embodiment of the invention. Table 3 illustrates the various stages of method 700 and the connections between them.

TABLE 3

| | | Next | Next | |
|---|---|---|---|---|
| | | stage if | stage if | Next |
| # | description | “yes” | “no” | stage |
| 702 | User A creates community Y | | | 704 |
| 704 | User A sets the properties of | | | 706 |
| | community Y and determines | | | |
| | a blanket agreement | | | |
| 706 | User A posts an invitation | | | 708 |
| | to join the community y on | | | |
| | a social network profile | | | |
| | of user A and status | | | |
| 708 | User B accepts the invitation | 710 | 720 | |
| | to join community Y? | | | |
| 710 | User B subscribes to the | | | 712, 720, |
| | blanket agreement | | | 726 |
| 712 | User B becomes a member of | | | — |
| | community Y | | | |
| 720 | User B promotes community Y | | | 722 |
| | through link share | | | |
| | and status network | | | |
| 722 | User C accepts the invitation | 724 | 728 | |
| | to join community Y? | | | |
| 724 | User C subscribes to | | | 726, 728 |
| | community Y | | | |
| 726 | Compensation event occurs | | | |
| 728 | User C promotes community Y | | | |
| | through link share | | | |
| | and status network | | | |

FIG. 9 illustrates method 800 according to an embodiment of the invention. Table 4 illustrates the various stages of method 800 and the connections between them.

TABLE 4

| | | Next | Next | |
|---|---|---|---|---|
| | | stage if | stage if | Next |
| stage # | description | “yes” | “no” | stage |
| 802 | User A creates product | | | 804 |
| 804 | User A sets the terms of | | | 806 |
| | transaction (including price) | | | |
| 806 | User A posts an invitation to | | | 808 |
| | buy the product on a social network | | | |
| | profile of user A and status | | | |
| 808 | User B accepts the invitation | 810 | 820 | |
| | to enter a transaction? | | | |
| 810 | Completion of transaction | | | 820, |
| | | | | 826 |
| 812 | User B becomes a member of | | | — |
| | community Y | | | |
| 820 | User B promotes the product through | | | 822 |
| | link share and status network | | | |
| 822 | User C accepts the offer to | 824 | 828 | |
| | purchase the product? | | | |
| 824 | Completion of transaction | | | 826, |
| | | | | 828 |
| 826 | Compensation event occurs | | | |
| 828 | User C promotes the product through | | | |
| | link share and status network | | | |

FIG. 10 illustrates a referral dispensing machine 900, according to an embodiment of the invention. The virtual referral module can be included in referral subsystem 110 of FIG. 1.

When a user is “exposed” through his friend's feeds to an offer to enter a transaction (such as an offer to purchase an item, to join a community) the user may do one of two things—go to the offering (and may be buying), or share the content.

While in prior art social networks the user simply posts the same URL under his profile, in the proposed referral dispensing machine the user receives a unique URL, that represents the forwarded URL, but at the time of the dispensing of this masked URL, he also registers himself to that “promotion chain”. To accomplish that mission, a referral dispensing machine 900 that applies a referral-URL dispensing mechanism is provided.

In phase 1, when a user presses the “Share button” (box 902), the referral dispensing machine 900 receives (the user “inserts”—box 904) the token the user was given by the publishing entity. The token includes a unique and “masked” URL provided by the system. The figure provides a URL such as REFURL.US that may help people create social campaigns without having the entire community built with the same mechanism.

The referral dispensing machine 900 then matches the token with the associated thread (thread of referrals), and it adds a new entry which identifies a continuation of the thread with the user that entered the token. This is illustrates by box 906 of “finding the original thread of referrals”, and box 908 of entering a new key entry with an increase in the hop index, and box 910 of “token out”. The hop index may be changed in other non-sequential manners.

The referral dispensing machine 900 returns a new “token” (box 910) with the new masked URL to the new publishing entity. The user then posts a new post with the new URL (box 912). The masked URL relates to an auto-forward function that may encapsulate the URL.

The assignment of a new URL is also followed by registering the participation of the user in the distribution efforts, as illustrated by box 922. A referral repository (920) is updated and the referral management subsystem 110 is notified.

When a user presses a join/buy icon (box 914), the new URL is sent to the referral dispensing machine 900 (box 926) and is received by a link forward decipher (box 924) that accesses the referral repository (920) that sends to the user (box 926) the URL of the initiating entity (or a URL of a portal that facilitates a completion of the transaction). Thus, the user is forwarded to the right landing web page (box 930) and can complete the transaction.

The information gathered in the referral dispensing machine 900 is fed to a referral subsystem 130 and a billing subsystem 110 that calculate either incentives or direct referral commissions.

FIG. 11 illustrates method 1100 according to an embodiment of the invention.

Method 1100 starts by stage 1110 of monitoring an offer to enter a transaction, wherein the offer is being distributed over a social networking community by a referring entity. Members of the social networking community interact through a network. The monitoring may include receiving reports from members, receiving reports that transaction is being distributed from the social network infrastructure, receiving reports from a “token dispensing” mechanism, and the like.

Stage 1110 is followed by stage 1120 of detecting a completion of the transaction.

Stage 1120 is followed by stage 1130 of compensating the referring entity, wherein the referring entity differs from an initiator of the offer.

Stage 1110 may include stage 1112 of monitoring multiple distribution attempts of the offer over multiple communities.

Stage 1130 may include compensating referring entities that initiated distribution attempts that directly contributed to the completion of the transaction.

Stage 1110 may include stage 1114 of monitoring multiple distribution attempts of the offer over multiple communities and assigning an identifier to each distribution attempt; wherein an identifier of a certain distribution attempt is indicative of a referring entity that initiated the certain distribution attempt and of at least one preceding distribution attempt that triggered the generation of the certain distribution attempt.

Stage 1110 may include stage 1116 of monitoring a virtual negotiation between the initiator of an offer an a third party, wherein the virtual negotiation is conducted by using an access controlled virtual environment after the third party received the offer via the virtual network.

Stage 1130 may be followed by stage 1140 of printing a receipt indicative of a completion of the transaction.

Stage 1112 may include monitoring multiple distribution attempts of the offer by tracking after social networking share operations.

Stage 1110 may also include stage 1118 of detecting a contribution to the social networking community, wherein the contribution is made by a contributing member of the virtual member.

Stage 1130 may include stage 1138 of compensating the contributing entity.

Stage 1118 may include detecting a contribution that is not directly attributed to the completion of the transaction.

Method 1100 can be executed by a computer that accesses or retrieves code stored in a non transient computer readable medium of a computer program product. Non-limiting examples of a computer readable medium include a disk, a diskette, a tape, a memory chip, and the like.

FIGS. 12A and 12B illustrate portions 1210, 1220, 1230, 1240, 1250 of a webpage that is displayed to users that access a social networking website according to an embodiment of the invention.

It is noted that each of these portions may include fewer or more fields and that a single webpage can includes one or more of these portions.

Portion 1210 includes an image 1211 of a user (either the initiating entity or the last referral entity), a brief description 1212 of the offer to enter a transaction and two buttons—a “share” button 1213 and a “sell” button 1214.

Portion 1220 illustrates a product definition and includes the following fields: product name field 1221, product creator (initiating entity) field 1222, product description field 1223, product type field 1224, product price fields 1225 and 1226.

Portion 1230 illustrates a community creation and includes the following fields: community name field 1231, community creator (initiating entity) field 1232, type of community creator field 1233 (user, community, sub-community), community description field 1234, community manager field 1235, subscription to membership approval field 12351, price fields 1236, period of membership field 1238, membership agreement link field 1239 and browse field 1237.

Portion 1240 illustrates a community creation and includes the following fields: community name field 1241, community creator (initiating entity) field 1242, type of community creator field 1243 (user, community, sub-community), community description field 1244, community manager field 1245, subscription to membership approval field 12451, price fields 1246, period of membership field 1248, price fields 1246, period of membership field 1238, membership agreement link field 1249 and browse field 1247.

Portion 1250 includes an image 1251 of a user (either the initiating entity or the last referral entity) that initiated a social network community, a brief description 1252 of the offer to enter a transaction (by becoming a member of the social network community) and two buttons—a “share” button 1253 and a “sell” button 1254.

Portion 1260 includes a list of the social network community members, their roles and their right (ownership rights, voting rights).

FIG. 13 illustrates a virtual environment 1300 according to an embodiment of the invention.

The virtual environment 1300 includes: (i) social networking hub 1390 that is accessible to the entire members of a certain social networking community, (ii) members areas such as members area 1393, (iii) public halls such as public hall 1394, and (iv) meeting rooms such as show room 1392 and deal room 1391.

Members area 1393 may be accessed by each member of the certain social networking community, by invitation only. Members may include individuals from the various (preselected) constituencies such as originators, investment bankers, investors, related executives (marketing, legal), partner businesses, attorneys, accountants, service providers, and other approved individuals, who may facilitate interactions.

Meetings areas may be defined for specific purposes—for example for completing a certain transaction. The members that access (or are allowed to access a meeting area form a sub-community of the certain social networking community. Show room 1392 is a relatively “open” room and may be initially accessed without many (or without any prerequisites). The access to deal room 1391 is more restricted. Access control and security mechanisms are applied to protect confidential information that may be exchanged in deal room 1391.

Public hall 1394 is a virtual space where people would be able to “hang-out” and “meet” fellow members from similar settings. Being a more open space, yet with a controlled access, it may feature virtual electronic boards (such as information exchange, briefings, analysis company announcements, etc.). The members that may access the public hall form a sub-community.

FIGS. 14 and 15 illustrate various transactions according to an embodiment of the invention.

FIG. 14 illustrates that deal room 1391 can be initially accesses by a member (John 1301) that offers to enter a transaction and at a first stage provides the general outlines of the transaction. Deal room 1391 is also accessed by interest group 1303. Some members of the interest group form a specific interest group 1305 that are interested to receive more information about the transaction. These members, once fulfilling a certain requirement (such as paying a fee, signing a non-disclosure agreement) can virtually pass a “flood door” of the deal room 1391 and may receive additional information relating to the transaction. Some of the members (such as Jane and Janine) 1307 of the specific interest group 1305 may wish to complete the transaction and the transaction may be completed within one or all of these final parties in the deal room 1391.

FIG. 15 illustrates a social networking website (“Consilyum”) that once accessed allows a system such as system 100 of FIG. 2 to manage transactions. This social networking website is accessed by members of a social networking community such as John, Jane, Mary and Jake. FIG. 15 illustrates John as publishing (1403) in the social networking website an offer to enter a transaction. The offer is associated with a unique token (1402). Jane may view (1404) the offer and may either publish it or complete the transaction (now shown in FIG. 16). Mary may re-publish the offer (1406) or publish (1409) another offer that is associated with another unique token 1408. Jake may view (1410) the offer and may either publish it or complete the transaction (now shown in FIG. 16).

FIG. 16 illustrates method 1600 according to an embodiment of the invention.

Method 1600 starts by stage 1610 of detecting, by a monitor, a completion of a transaction made between a first group of members of a social networking community and a second group of members of another social networking community; wherein an offer to enter the transaction was generated by the first group of members and was distributed over the social networking communities; wherein the members of the social networking communities interact through at least one network.

Stage 1610 is followed by stage 1620 of allocating, by a compensation module, funds received from the transaction between members of the first group of members based on an agreement between the members of the first group of members, the agreement being accessible to the compensation module. The compensation may include referral compensation, indirect compensation (double-dip) and the like.

Method 1600 may be executed by a computer that accesses a computer readable medium of a computer program product.

System 100 may execute method 1600. Monitor 160 may detect a completion of a transaction made between a first group of members of a social networking community and a second group of members of another social networking community; wherein an offer to enter the transaction was generated by the first group of members and was distributed over the social networking communities; wherein the members of the social networking communities interact through at least one network.

Compensation module 170 may allocate funds received from the transaction between members of the first group of members based on an agreement between the members of the first group of members, the agreement being accessible to the compensation module. The compensation may include referral compensation, indirect compensation (double-dip) and the like.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A computer program product that comprises a non transient computer readable medium that stores instructions for:
monitoring an offer to enter a transaction, wherein the offer is being distributed over a social networking community by a referring entity; wherein members of the social networking community interact through a network;
detecting a completion of the transaction; and
compensating the referring entity, wherein the referring entity differs from an initiator of the offer.

2. The computer program product according to claim 1, wherein the computer readable medium stores instructions for:
monitoring multiple distribution attempts of the offer over multiple communities; and
compensating referring entities that initiated distribution attempts that directly contributed to the completion of the transaction.

3. The computer program product according to claim 1, wherein the computer readable medium stores instructions for:
monitoring multiple distribution attempts of the offer over multiple communities; and
assigning an identifier to each distribution attempt; wherein an identifier of a certain distribution attempt is indicative of a referring entity that initiated the certain distribution attempt and of at least one preceding distribution attempt that triggered the generation of the certain distribution attempt.

4. The computer program product according to claim 1, wherein the referring entity is a community.

5. The computer program product according to claim 1, wherein the referring entity is a sub-community.

6. The computer program product according to claim 1, wherein the computer readable medium stores instructions for monitoring a virtual negotiation between the initiator of an offer an a third party, wherein the virtual negotiation is conducted by using an access controlled virtual environment after the third party received the offer via the virtual network.

7. The computer program product according to claim 1, wherein the computer readable medium stores instructions for printing a receipt indicative of a completion of the transaction.

8. The computer program product according to claim 1, wherein the computer readable medium stores instructions for monitoring multiple distribution attempts of the offer by tracking after social networking share operations.

9. The computer program product according to claim 1, wherein the computer readable medium stores instructions for:
detecting a contribution to the social networking community, wherein the contribution is made by a contributing member of the virtual member; and
compensating the contributing entity.

10. The computer program product according to claim 19, wherein the computer readable medium stores instructions for:
detecting a contribution that is not directly attributed to the completion of the transaction; and
compensating the contributing entity.

11. A system for virtual commerce comprising:
a monitor for monitoring an offer to enter a transaction, wherein the offer is being distributed over a social networking community by a referring entity;
wherein members of the social networking community interact through a network; and for detecting a completion of the transaction; and
a compensation module for compensating the referring entity, wherein the referring entity differs from an initiator of the offer.

12. The system according to claim 11 wherein the monitor is configured to monitor multiple distribution attempts of the offer over multiple communities; and wherein the compensation module is configured to compensate referring entities that initiated distribution attempts that directly contributed to the completion of the transaction.

13. The system according to claim 11, wherein the monitor is configured to monitor multiple distribution attempts of the offer over multiple communities and assign an identifier to each distribution attempt; wherein an identifier of a certain distribution attempt is indicative of a referring entity that initiated the certain distribution attempt and of at least one preceding distribution attempt that triggered the generation of the certain distribution attempt.

14. The system according to claim 11, wherein the referring entity is selected from a community and a sub-community.

15. The system according to claim 11, wherein the monitor is configured to monitor a virtual negotiation between the initiator of an offer an a third party, wherein the virtual negotiation is conducted by using an access controlled virtual environment after the third party received the offer via the virtual network.

16. The system according to claim 11, comprising printing a receipt indicative of a completion of the transaction.

17. The system according to claim 11, wherein the monitor is configured to monitor multiple distribution attempts of the offer by tracking after social networking share operations.

18. The system according to claim 11, wherein the monitor is configured to detect a contribution to the social networking community, wherein the contribution is made by a contributing member of the virtual member; and wherein the compensation module is configured to compensate the contributing entity.

19. The system according to claim 18, wherein the monitor is configured to detect a contribution that is not directly attributed to the completion of the transaction; and wherein the compensation module is configured to compensate the contributing entity.

20. A method, comprising:
monitoring an offer to enter a transaction, wherein the offer is being distributed over a social networking community by a referring entity; wherein members of the social networking community interact through a network;
detecting a completion of the transaction; and
compensating the referring entity, wherein the referring entity differs from an initiator of the offer.

21. A computer program product that comprises a non transient computer readable medium that stores instructions for:
detecting, by a monitor, a completion of a transaction made between a first group of members of a social networking community and a second group of members of another social networking community; wherein an offer to enter the transaction was generated by the first group of members and was distributed over the social networking communities; wherein the members of the social networking communities interact through at least one network; and
allocating, by a compensation module, funds received from the transaction between members of the first group of members based on an agreement between the members of the first group of members, the agreement being accessible to the compensation module.
